(19) United States
(12) Patent Application Publication
(10) Pub. No.: US 2008/0304088 A1
(43) Pub. Date: Dec. 11, 2008

(54) SECURE PRINT PROCESSING SYSTEM

(75) Inventor: TAISHI TOMIHISA, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/030,915

(22) Filed: Feb. 14, 2008

(30) Foreign Application Priority Data
Jun. 8, 2007 (JP) 2007-153201

(51) Int. Cl. G06K 1/00

(52) U.S. Cl. 358/1.9; 358/1.15

(57) ABSTRACT

A print processing system is provided that determines whether or not to execute processing for reducing reusability of a document image, such as image degradation processing and security image processing, based on information on a printer user. An information processing device sets a user-specified region to at least a portion of a region in a document image based on instructions from a user and sends a location of the user-specified region and the document image to a printer. The printer determines whether or not to execute image processing for deteriorating the document image for the user-specified region in the document image based on the information on the printer user. For example, the printer executes security image processing only when authority level of the printer user is low. Namely, a PC user can change executing the security image processing or not based on the authority level of the printer user.

### BACKGROUND OF THE INVENTION

1. Field of the Invention

The present invention relates to a print processing system for deteriorating visibility of at least a portion of an image region.

2. Description of the Related Art

As security consciousness heightens in recent years, technique for management of printed paper has drawn attention. As an example of the technique, “security image printing” is well known. The security image printing is the technique utilizing limit of copying capability of copier (scanner, etc.). In the security image printing, a security image where a character string such as “No copy” is contained is combined with a document image and the composite image is printed on paper. When the printed paper is copied, the contained “No copy” string appears on a surface of duplicated paper, which leads to effects of hesitating in using the duplicated paper, preventing from coping the duplicated paper and warning against copying it.

A detailed description of the security image will be given hereinafter. The character string such as “No copy” is contained in the security image so that the character string is not seemingly visible to anyone looking at the image. The contained string appears on the surface of the duplicated paper when the printed paper containing the security image is copied. As a result, it is possible to easily differentiate the duplicated paper from the printed paper containing the composite image of the security image and the document image.

The security image is composed of a region where an image, when copied, appears on the duplicated paper and a region where an image disappears or an image becomes weak when compared to the region where the image appears. The two regions are of almost the same density when printed out and the contained character string is seldom visible to the naked eye. Hereinafter, the region that appears when copied will be called a “latent image region” and the region that disappears or becomes weak when copied will be called a “background image region”.

FIG. 8 is a schematic view showing a state of dots in the security image and visualization of the latent image. The region where the dots are arranged in densely-dispersed is the latent image region. In contrast, the region where the dots are arranged in coarsely-dispersed form is the background image region. The dots in the two regions are generated by distinct half-tone dot processing or distinct dither processing. For example, the dots in the latent image region are generated by a small number of lines per inch halftone dot processing, while the dots in the background image are generated by a large number of lines per inch halftone dot processing. Alternatively, the dots in the latent image region are generated using a dot-concentrated type dither matrix, while those in the background image region are generated using a dot-dispersion type matrix. Because the copying capability of the copier depends on input/output resolution of the copier, the limit of the copying capability exists. Accordingly, the dots in the latent image region on the duplicated paper can be reproduced easily, whereas the dots in the background image region cannot be reproduced easily. That is, when the dots in the latent image region of the security image are formed larger than dots that can be reproduced by the copier and the dots in the background image region are formed smaller than the dots that can be reproduced by the copier, the latent image region can be reproduced thickly in comparison to the background image region. The contained character string appears on the surface of the duplicated paper by having the latent image region reproduced thickly in comparison to the background image region. The phenomenon is called “visualization”. In the lower part of FIG. 8, the visualization of the latent image is shown. The Figure shows on a conceptual basis that the densely-dispersed dots (or large dots) are reproduced on the duplicated paper whereas the coarsely-dispersed dots (or small dots) are not accurately reproduced on the duplicated paper.

Furthermore, the security image is not limited to just the above configuration but may be configured so that character string of, for example, “No copy” that can be recognized by users or symbols or patterns is visualized. Additionally, even if the character string “No copy” appears in outline characters on the duplicated paper, the effect of the security image is achieved.

The security image is printed together with a document image on a same paper. Content of the document image is one that should be prevented from the use of the duplicated paper. In conventional security image printing, the security image is printed on whole region of paper on which a document image is printed (refer to Japanese Patent Laid-Open No. 2001-197297). In the technique disclosed in Japanese Patent Laid-Open No. 2001-197297, whether to apply the security image printing or not is selected by physical page unit. In the technique, therefore, a problem exists that the security image printing cannot be controlled so that the security image printing is executed in a portion of a region on paper and is not executed in the remaining region. In another conventional technique, for a physical page, a region where the security image is applied or a region where the security image is not applied is specified through a user interface, and the security image printing is only executed in the region where the security image is applied (refer to Japanese Patent Laid-Open No. 2005-235181). This technique resolves the above-described problem. For example, the following is described in Japanese Patent Laid-Open No. 2005-235181.

When a user specifies, through a user interface in a PC (host computer), a location in a document image where a security image is combined, the PC generates the security image which will be combined with the document image at the location and sends the document image and the security image to a printer. The printer combines the document image with the security image, which are received from the PC. The size of the security image is smaller than the document image.

According to the technique disclosed in Japanese Patent Laid-Open No. 2005-235181, the user can combine the document image with the security image at a user-specified location in the document image. However, in the technique disclosed in Japanese Patent Laid-Open No. 2005-235181, the location inside the document image where the security image is combined with the document image is specified by a user. Consequently, a restriction exists that the location where the security image is combined is determined in a uniform manner because the location is specified by the user. Furthermore, a PC user may prefer not to combine the security image with a printed document when a person who the PC user can trust will print a document image. In contrast, a PC user may prefer to combine the security image with a printed document when a person who the PC user cannot trust will print a document image. However, for these cases, with the technique in Japanese Patent Laid-Open No. 2005-235181, the PC user cannot select whether to execute security image processing or not in accordance with information on a printer user. Additionally, operating burden imposed on the user is great because the user needs to specify the location in the document image where the security image is combined. Additionally, if error in operation by the user occurs, combining the security image processing is not executed at an appropriate location where the security image should be combined.

### SUMMARY OF THE INVENTION

One aspect of the present invention provides a system and a method for determining whether or not to execute processing, such as image degradation processing or security image processing, for decreasing reusability of a document image for a PC user-specified image region in accordance with information on a printer or a printer user.

A print processing system of the present invention comprises an information processing device and a printer. The information processing device sets a user-specified region to at least a portion of a region in a document image in accordance with instructions from a user to send a location of the user-specified region and the document image. The printer receives the location of the user-specified region and the document image sent from the information processing device to determine whether or not to execute image processing for deteriorating the document image for the user-specified region in the received document image in accordance with user information on a printer user.

An information processing device of the present invention comprises a component for setting a user-specified region to at least a portion of a region in a document image in accordance with instructions from a user and a component for sending a location of the user-specified region and the document image to a printer. The printer determines whether or not to execute image processing for deteriorating the document image for the user-specified region in the document image in accordance with user information on a printer user.

An image forming device of the present invention comprises a component for specifying at least a portion of a region in a document image as a user-specified region in accordance with information contained in PDL data, the user-specified region representing a region where copying is inhibited, and a component for superimposing a security image on the user-specified region.

A print processing method of the present invention comprises the steps of setting a user-specified region to at least a portion of a region in a document image in accordance with instructions from a user, sending a location of the user-specified region and the document image, receiving the location of the user-specified region and the document image and determining whether or not to execute image processing for deteriorating the document image for the user-specified region in the received document image in accordance with user information on a printer user.

An image forming method of the present invention comprises the steps of specifying at least a portion of a region in a document image as a user-specified region in accordance with information contained in PDL data, the user-specified region representing a region where copying is inhibited, and superimposing a security image on the user-specified region.

According to the present invention, it becomes possible to easily and rapidly execute processing for deteriorating visibility, for example security image processing, for a specific region (e.g., an object whose level of importance is high) specified by a PC user in a document image, in accordance with user information on a printer user.

Further features of the present invention will become apparent from the following description of exemplary embodiments (with reference to the attached drawings).

### BRIEF DESCRIPTION OF THE DRAWINGS

FIG. 1 is a schematic view of a print processing system in which the embodiments of the present invention operates;

FIG. 2 is a flowchart showing print processing executed by a printer according to the first embodiment of the present invention;

FIG. 3A is a schematic view showing security images;

FIG. 3B is a schematic view showing security images;

FIG. 4 is a flowchart showing PDL data generation processing executed by an information processing device according to the second embodiment of the present invention;

FIG. 5 is a flowchart showing print processing executed by a printer according to the second embodiment of the present invention;

FIG. 6 is a flowchart showing print processing executed by a printer according to the third embodiment of the present invention;

FIG. 7A is a schematic view showing an image obtained by executing processing according to the third embodiment;

FIG. 7B is a schematic view showing an image obtained by executing processing according to the third embodiment;

FIG. 7C is a schematic view showing an image obtained by executing processing according to the third embodiment; and

FIG. 8 is a schematic view showing a state of dots in a security image.

### DESCRIPTION OF THE EMBODIMENTS

The embodiments of the present invention will be described in detail below with reference to the attached drawings.

In the embodiments, a MFP (Multi Function Printer) will be given as an example of a printer (or image forming device), but an SFP (Single Function Printer, LBP (Laser Beam Printer) or an ink-jet printer may also be given.

### <Overview of the Print Processing System>

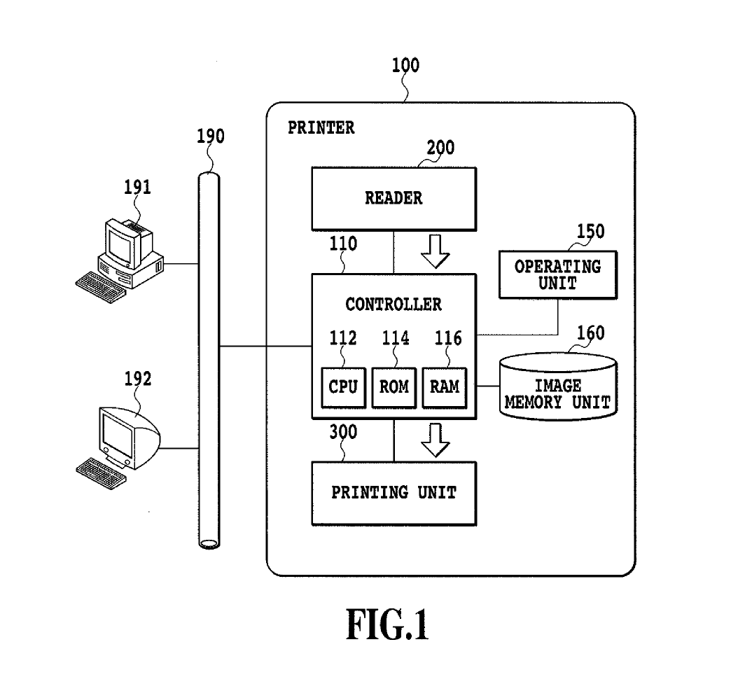

FIG. 1 is a schematic view showing an example of a print processing system according to the embodiments of the present invention.

The print processing system comprises a printer 100 and PCs 191 and 192 (information processing devices). The printer 100 is connected to the PCs 191 and 192 via LAN (Local Area Network) 190 such as Ethernet.

The printer 100 comprises a reader 200, a printing unit 300, an operating unit 150, an image memory unit 160 and a controller 110.

The controller 110 comprises a CPU 112, a ROM 114 and a RAM 116. The CPU 112 executes overall control for the printer 100 in accordance with computer programs stored in the ROM 114 or other computer-readable media. The RAM 116 is used as a work area for the CPU 112.

The reader 200 scans image data. The printing unit 300 forms an image on paper. The operating unit 150 comprises a keyboard for input/output operations for the image data and a liquid crystal panel for displaying/setting the image data and the various functions.

The image memory unit 160 stores the image data scanned by the reader 200. Furthermore, the image memory stores ESC codes and image data generated from print control language such as PDL, which are, for example, sent from the PC 191 via the LAN 190.

The embodiments of the present invention will be described in detail using an example of the above-mentioned print processing system.

### The First Embodiment

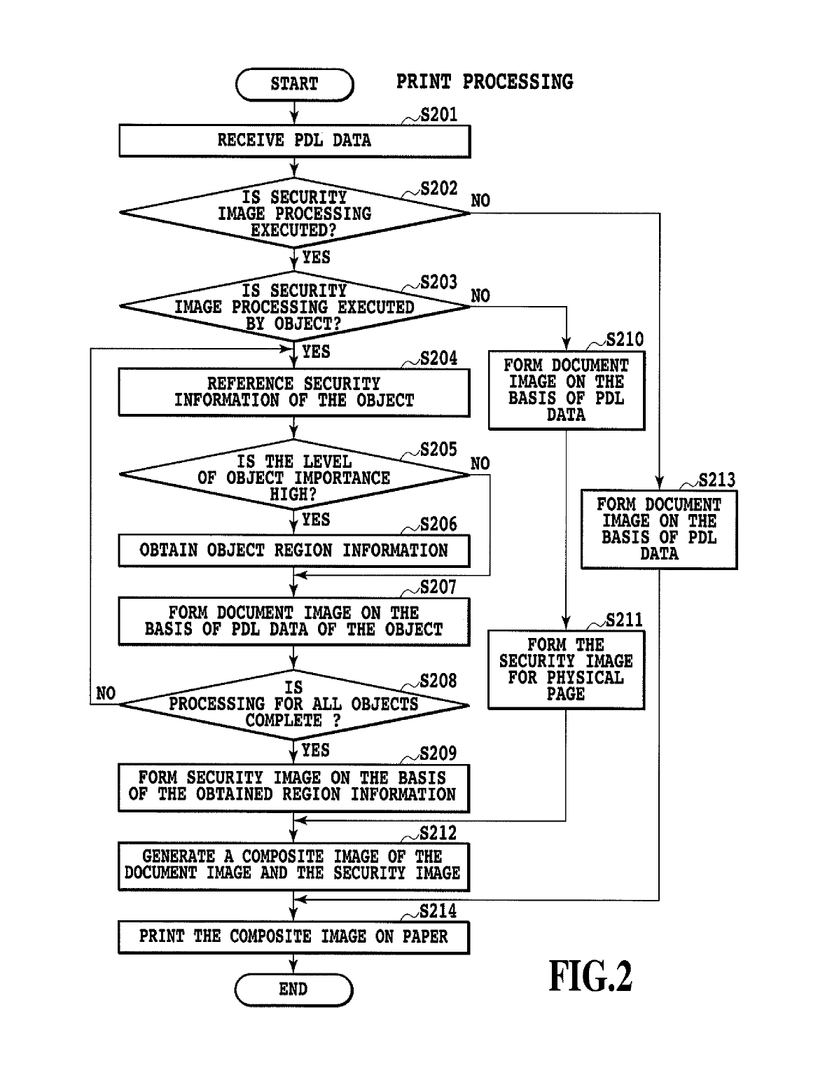

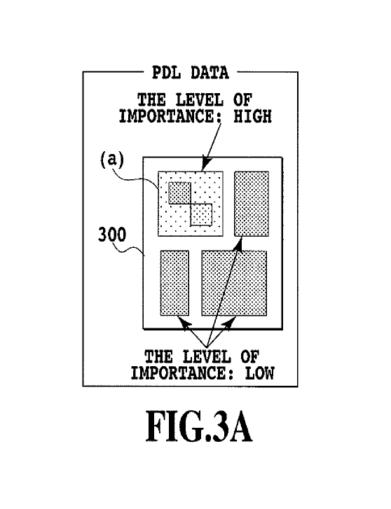

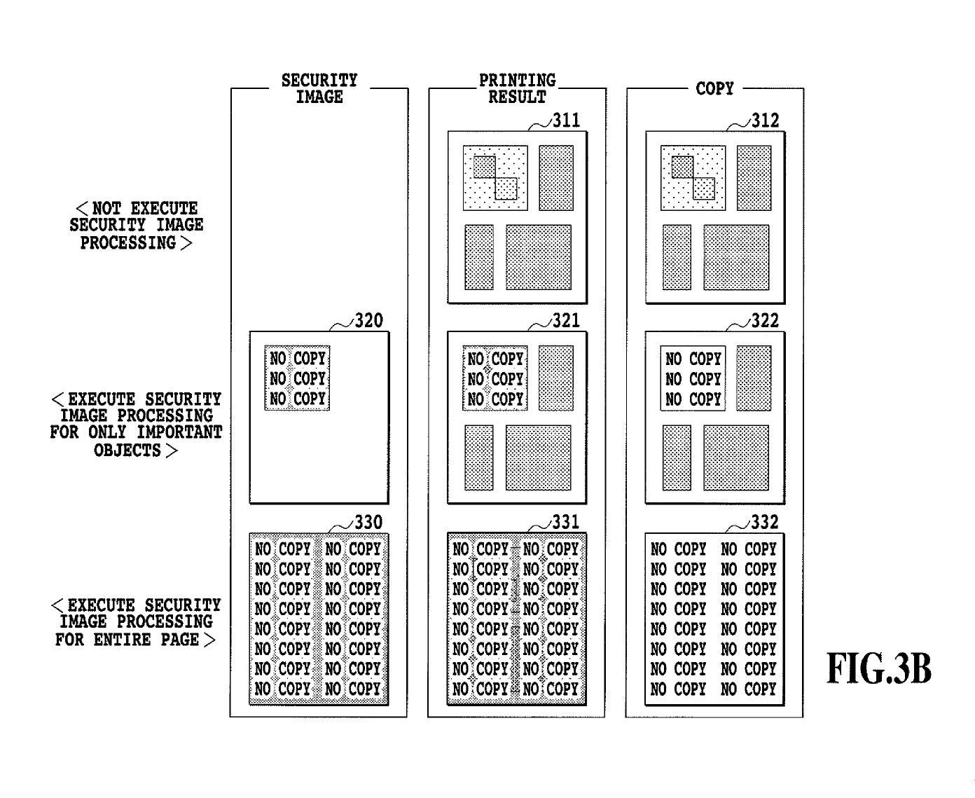

FIG. 2 is a flowchart showing print processing executed by the printer 100 according to the first embodiment. FIGS. 3A and 3B are schematic views showing security images. The first embodiment will be described with reference to FIGS. 2, 3A and 3B.

In Step 201, the printer 100 receives PDL data from the PC 191. The printer 100 may also read the PDL data from storage for storing the PDL data. The PDL data is prepared in the form of a language specification where security information for inhibiting copying by a printer user is settable for various drawing objects such as graphics or images. The printer 100 can process the PDL data. As shown in the PDL data 300 of FIG. 3A, object (a) with high importance and objects with low importance are mixed in the PDL data. Information (copy-inhibited information) on whether or not to inhibit copying of a printer user is set for each object by a PC user. Or, copy-inhibited information is set for an entire physical page by the PC user.

In Step 202, the printer 100 determines whether or not to execute security image processing. When the security image processing is determined to be executed, the process proceeds to Step 203, or the process proceeds to Step 213. Specifically, the printer 100 determines whether or not to execute security image processing for one or more user-specified regions (individual objects or physical pages) to which copy-inhibited information has been set by the PC user, in accordance with information on a user of the printer 100. That is, the printer 100 determines to execute the security image processing for the user-specified region when a specific printer user will print, and determines not to execute the security image processing when other printer user will print. The determination of whether the printer user is specific or not is made in accordance with user information on the printer user. As an example of the user information, authorization level of a user using the printer 100 is given. When the authorization level of the user using the printer 100 is low, the security image processing is executed for the user-specified region, or the security image processing is not executed. That is, the PC user can select executing the security image processing for the user-specified region or not in accordance with the authorization level of the printer user.

Hereinafter, executing security image processing represents combining the security image with a document image. Also, executing security image processing for each object represents combining the security image with an object (e.g. object with a high security) in a document image. Furthermore, executing security image processing on an entire physical page represents combining the security image with an entire document image.

In Step 203, the printer 100 determines whether to execute the security image processing for each object or execute the security image processing for the entire physical page. When the security image processing is executed for each object, the process proceeds to Step 204. When the security image processing is executed for the entire physical page, the process proceeds to Step 210.

In Steps 204 to 208, the printer 100 forms document image and acquires one or more regions where the security image processing are executed, in accordance with the PDL data received in Step 201, which is as follows.

In Step 204, the printer 100 references security information of the object in the document image.

In Step 205, the printer 100 determines whether the level of object importance is high or low in accordance with the security information referenced in Step 204. When the printer 100 determines that the level of object importance is high, the process proceeds to Step 206, otherwise it proceeds to Step 207.

In Step 206, the printer 100 receives region information on the region containing the object with high importance.

In Step 207, the printer 100 forms the document image in accordance with the PDL data of the object.

In Step 208, the printer 100 determines whether or not the processing is completed for all the objects. When non-processed object exists, the process returns to Step 204. When the processing is completed for all the objects, the process proceeds to Step 209.

In Step 209, the printer 100 forms the security image in accordance with the region information of the object with high importance obtained in Step 206. That is, in Step 209, the printer 100 processes the PDL data 300 to form the security image 320. Forming an image represents generating and preparing image data.

In Step 212, the printer 100 generates a composite image of the document image formed in Step 207 and the security image formed in Step 209.

In Step 214, the printer 100 prints the composite image generated in Step 212 on paper using the printer unit 300. In this case, the image 321 is shown as a printing result.

When it is determined in Step 203 that the security image processing is executed on the entire physical page, in Step 210 the printer 100 forms a document image in accordance with the PDL data received in Step 201.

In Step 211, the printer 100 forms the security image for the physical page where the security image is applied. That is, in Step 211, the printer 100 processes the PDL data 300 to form the security image 330. The printer 100 then executes the processing of the above-described Steps 212 and 214 and prints the image 331 as a printing result.

When it is determined in Step 202 that the security image processing is not executed, in Step 213 the printer 100 forms a document image in accordance with the PDL data obtained in Step 210. Subsequently, the printer 100 executes the processing of the above-described Step 214 to print the image 311 as a printing result.

The duplicated paper 312, 322 and 332 shown in FIG. 3B represent results obtained by copying the printed paper obtained in Step 214. The duplicated paper 312 has almost the same image as that in the printing result 311. The duplicated paper 322 contains an image where the latent image appears obviously on only the object with high importance (a) in the PDL data 300. The duplicated paper 332 contains an image where the latent image appears obviously on the entire page.

### The Second Embodiment

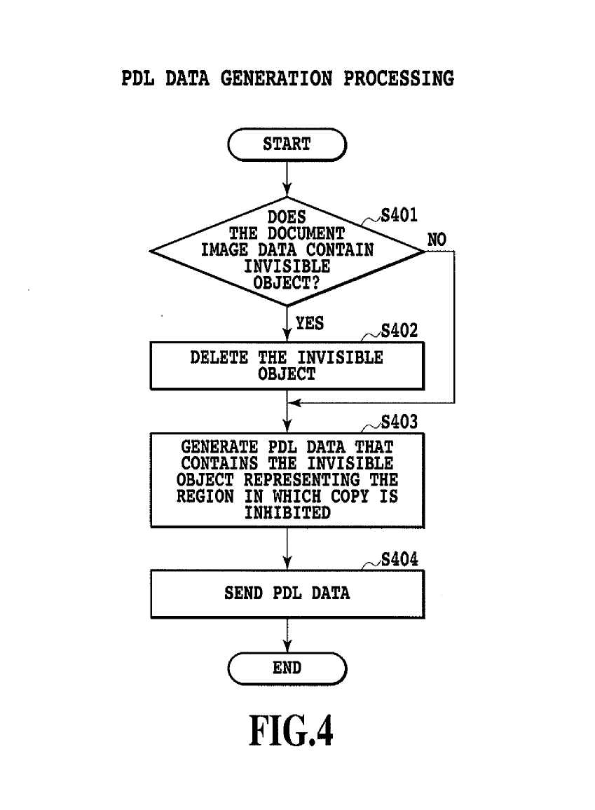

FIG. 4 is a flowchart showing PDL data generation processing executed by the PC 191 according to the second embodiment. Unlike the first embodiment, the PDL data is prepared in the form of a language specification where security information for inhibiting copying by a specific user is not settable for various drawing objects such graphics or images.

In Step 401, the PC 191 determines whether or not a document image data contains an invisible object. The invisible object represents a non-drawn data type object with a completely transparent (alpha value=0) or ROP (raster operation processing) background image when the PDL data is rendered. The ROP processing represents a drawing operation processing executed when two or more drawing objects (raster images) are superimposed. By executing ROP processing, it is possible not only to just overwrite in the form of hierarchical relationship but also to provide results such as a “watermark” or “inversion”.

In Step 401, when the invisible object is contained, the process by the PC191 proceeds to Step 402. When the invisible object is not contained, the process proceeds to Step 403.

In Step 402, the PC 191 deletes the invisible object contained in the document image data. The reason is that there is no need to send the invisible object, which is not printed, to the printer 100.

In Step 403, the PC 191 generates a new invisible object representing a location of a user-specified region in the document image and generates the PDL data with the invisible object. The user-specified region represents a portion of a region inside the document image and represents a region set up in accordance with instructions from a user of the PC 191. In this manner, an entire transparent plane (alpha value=0) made vacant by the removal of the invisible object in Step 402 is used as a plane representing the user-specified region. Moreover, the plane represents a region where information is described. According to the embodiment, because R is 0 to 255, G is 0 to 255, B is 0 to 255 and the alpha value is 0 to 100, 256×256×256×100 planes are available.

In Step 404, the PC 191 sends the PDL data generated in Step 403 to the printer 100.

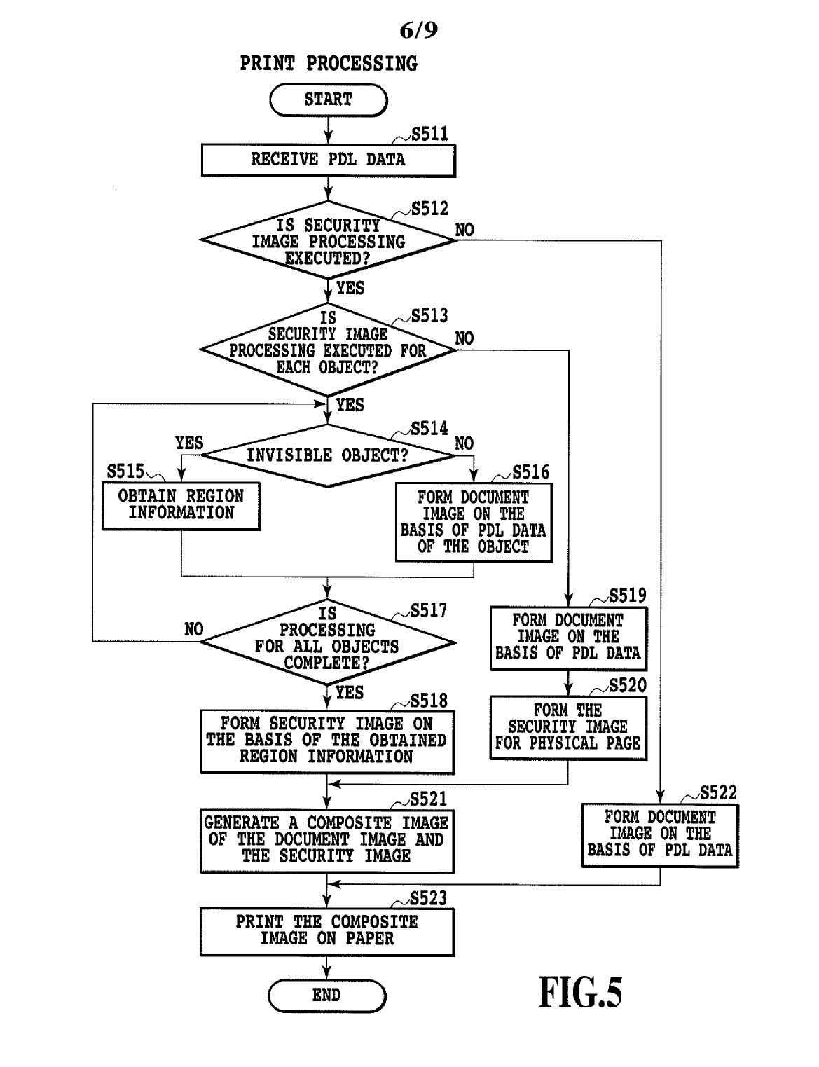

FIG. 5 is a flowchart showing the printing processing executed by the printer 100 according to the second embodiment.

In Step 511, the printer 100 receives the PDL data from the PC 191.

In Step 512, the printer 100 determines whether or not to execute the security image processing. When the security image processing is determined to be executed, the process proceeds to Step 513, or the process proceeds to Step 522. The printer 100 determines whether or not to execute the security image processing in accordance with configuration information of a printer driver of the PC 191, information on a printer user using the printer 100 or data appended to the PDL data.

In Step 513, the printer 100 determines whether to execute the security image processing for each object or to execute the security image processing for an entire physical page. When the security image processing is determined to be executed for each object, the process proceeds to Step 514. When the security image processing is determined to be executed for the entire physical page, the process proceeds to Step 519.

In Step 514, the printer 100 determines whether or not the object for security image processing is an invisible object appended in Step 403. When the object is the invisible object, the process proceeds to Step 515, or the process proceeds to Step 516.

In Step 515, the printer 100 obtains the user-specified region from the invisible object.

In Step 516, the printer 100 forms the document image in accordance with the PDL data of the object.

In Step 517, the printer 100 determines whether or not the processing is completed for all the objects. When non-processed object exists, the process returns to Step 514. When the processing is completed for all the objects, the process proceeds to Step 518.

In Step 518, the printer 100 executes the security image processing at a location of the user-specified region obtained in Step 515 and forms the security image.

In Step 521, the printer 100 generates a composite image of the document image formed in Step 516 and the security image formed in Step 518.

In Step 523, the printer 100 prints the composite image on paper using the printer unit 300.

When it is determined in Step 513 that the security image processing is not executed for each object, in Step 519 the printer 100 forms a document image in accordance with the PDL data obtained in Step 511. Then, in Step 520, the printer 100 forms the security image for the physical page to which the security image is applied. Then the printer 100 executes the above-described processing of Steps 521 and 523 and prints the composite image of the document image and the security image on paper using the printer unit 300.

When it is determined in Step 512 that the security image processing is not executed, in Step 522 the printer 100 forms a document image in accordance with the PDL data received in Step 511. Then the printer 100 executes the above-described processing of Step 523 and prints the document image on paper using the printer unit 300.

As described above, the printer 100 executes the security image processing for an image in a region indicated by the invisible objects in order to deteriorate visibility of an object with high importance, that is, deteriorate image quality of the object.

On the other hand, when a commonplace printer other than the printer 100 (which cannot execute processing in the flowchart shown in FIG. 5) receives the above-described PDL data, a portion of a plane with an alpha value of 0 is never reflected in the printed paper. This is because it is impossible for the commonplace printer to execute the processing of Steps 515 to 518.

As a result, only a specific printer which can execute the processing of Steps 515 to 518 in the flowchart shown in FIG. 5 is able to deteriorate image quality, whereas the commonplace printer is not able to deteriorate image quality.

As described above, according to the second embodiment, the information processing device uses a completely transparent object. In this manner, it is possible to prepare PDL data (printing data) which allows the commonplace printer not to generate high security printed paper, but which allows the specific printer to generate high security printed paper.

### The Third Embodiment

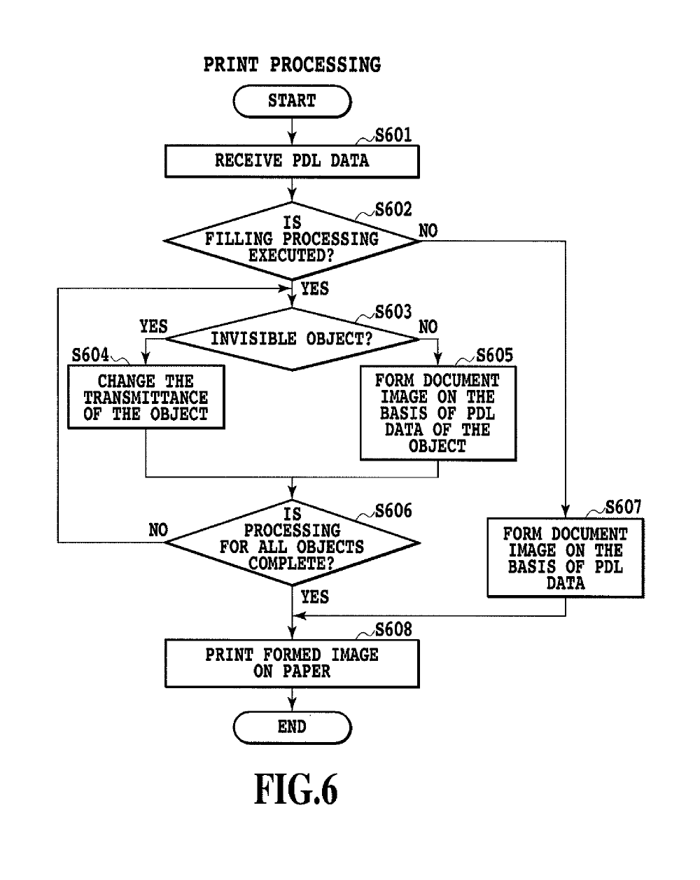

FIG. 6 is a flowchart showing the print processing executed by the printer 100 according to the third embodiment.

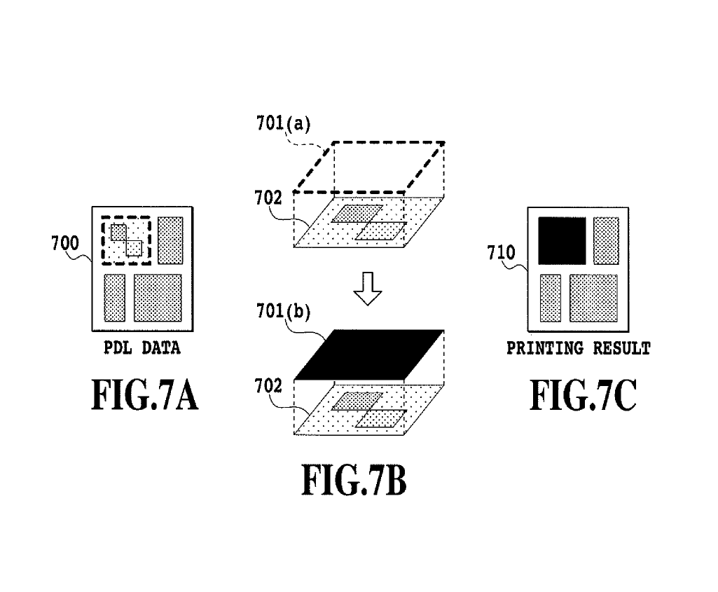

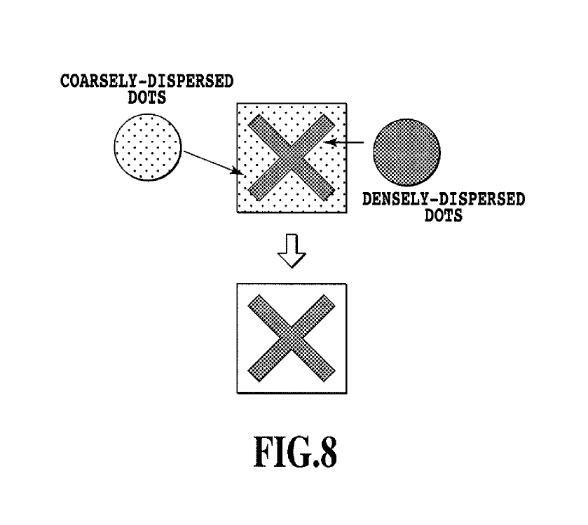

In Step 601, the printer 100 receives PDL data from the PC 191. As shown in the PDL data 700 of FIG. 7A, the invisible object 701 (a) shown in FIG. 7B generated by the processing in Step 403 in FIG. 4 is superimposed on the object with high importance 702. The invisible object 701 (a) corresponds to security information. The invisible object 701 (a) is prepared in the form of PDL language specification. The invisible object 701 (a) represents a completely transparent, monochromatic black rectangle.

In Step 602, the printer 100 determines whether or not to execute filling processing for deteriorating visibility of the object with high importance 702. When it is determined that the filling processing is executed, the process proceeds to Step 603. When it is determined that the filling processing is not executed, the process proceeds to Step 607. The printer 100 determines whether or not to execute the filling processing in accordance with user information on a user using the printer 100.

In Step 603, the printer 100 determines whether or not the invisible object 701 (a) resides. When it is determined that the invisible object 701 (a) resides, the process proceeds to Step 604, or the process proceeds to Step 605.

In Step 604, the printer 100 executes the filling for the object with high importance 702 by changing transmittance of the invisible object 701 (a). In this manner, it is possible to deteriorate visibility of the object with high importance. For example, when the transmittance of the invisible object 701 (a) is changed to being completely non-transparent, the object 701 (b) shown in FIG. 7B is generated. Moreover, the transmittance may be set up in accordance with user information (user authority level) on a user using the printer 100.

In Step 606, the printer 100 determines whether or not the processing is completed for all the objects. When non-processed object exists, the process returns to Step 603. When the processing is completed for all the objects, the process proceeds to Step 608.

In Step 608, the printer 100 prints image obtained by deteriorating the visibility of the object 702 with high importance 702 on paper using the printing unit 300. The printing result 710 shown in FIG. 7C represents the image obtained by deteriorating the visibility of the object 702 with high importance.

When it is determined in Step 603 that the invisible object does not exist, in Step 605 the printer 100 forms a document image in accordance with the PDL data of the object. Then the printer 100 executes the above-described processing of Steps 606 and 608.

When it is determined in Step 602 that the filling processing of the object with high importance is not executed, in Step 607 the printer 100 forms a document image in accordance with the PDL data obtained in Step 601. Then the printer 100 executes the above-described processing of Step 608.

The third embodiment uses the invisible object to deteriorate the visibility of the object with high importance, which is common to the second embodiment. However, according to the third embodiment, the printer deteriorates image quality by changing the transmittance of the object instead of executing the security image processing. Therefore, it is possible to attain faster processing than the second embodiment in which the security image processing is executed.

Moreover, according to the third embodiment, the changing of the transmittance of the invisible object is executed with respect to each object, but the transmittance of a plurality of invisible objects may be changed collectively. This allows the visibility of an object with high importance to be deteriorated faster.

### Other Embodiments

The objective of the present invention is attained by having a system or a computer (or CPU or MPU) reading and executing program codes from a recording medium storing the program code for realizing the steps of the flowcharts described above. The recording medium represents computer-readable medium. In this case, the program code read from the computer-readable medium executes the functions of the embodiments described above. As a result, the program code and the computer-readable medium in which the program codes are stored constitute the present invention.

Floppy disk, hard disk, optical disk, optical-magnetic disk, CD-ROM, CD-R, magnetic tape, nonvolatile memory card and ROM may be used as a recording medium to provide the program code.

An OS (operating system) operating in a computer in accordance with instructions of the program code executes a partial processing or a complete processing. The above-described embodiments may be achieved by the processing.

Program codes which are read from a recording medium are written into a memory provided in a function enhancement board inserted into a computer or a function enhancement unit connected to a computer. Then a CPU provided in the function enhancement board or the function enhancement unit executes a partial processing or a complete processing in accordance with instructions of the program codes. As a result, the above-described embodiments may be achieved by the processing.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-153201, filed Jun. 8, 2007, which is hereby incorporated by reference herein in its entirety.

What is claimed is:

1. A print processing system, comprising:
an information processing device for setting a user-specified region to at least a portion of a region in a document image in accordance with instructions from a user to send a location of the user-specified region and the document image; and
a printer for receiving the location of the user-specified region and the document image sent from the information processing device to determine whether or not to execute image processing for deteriorating the document image for the user-specified region in the received document image in accordance with user information on a printer user.

2. The print processing system of claim 1, wherein the user-specified region is at least a portion of a region in the document image where an object is drawn, the user-specified region being specified by copy-inhibited information appended to the object.

3. The print processing system of claim 1, wherein the user-specified region is at least a portion of a region in the document image specified by an invisible object that is not printed out due to complete transparence.

4. The print processing system of claim 1, wherein the user-specified region is at least a portion of a region in the document image specified by an invisible object that is not printed out due to drawing operation with raster operation processing.

5. The print processing system of claim 1, wherein the user information on the printer user includes authorization level of the printer user.

6. The print processing system of claim 3, wherein the printer changes transmittance of the invisible object when determining to execute the image processing for deteriorating the document image.

7. The print processing system of claim 6, wherein the printer changes the transmittance of a plurality of the invisible objects collectively.

8. The print processing system of claim 6, wherein the printer sets the transmittance in accordance with user information on the printer user.

9. The information processing device, comprising:
a component for setting a user-specified region to at least a portion of a region in a document image in accordance with instructions from a user; and
a component for sending a location of the user-specified region and the document image to a printer;
wherein the printer determines whether or not to execute image processing for deteriorating the document image for the user-specified region in the document image in accordance with user information on a printer user.

10. The information processing device of claim 9, wherein the user-specified region is at least a portion of the region in the document image where an object is drawn, the user-specified region being specified by copy-inhibited information appended to the object.

11. An image forming device, comprising:
a component for specifying at least a portion of a region in a document image as a user-specified region in accordance with information contained in PDL data, the user-specified region representing a region where copying is inhibited; and
a component for superimposing a security image on the user-specified region.

12. The image forming device of claim 11, wherein the user-specified region is at least a portion of a region in the document image specified by an invisible object that is not printed out due to complete transparence.

13. A print processing method, comprising the steps of:
setting a user-specified region to at least a portion of a region in a document image in accordance with instructions from a user;
sending a location of the user-specified region and the document image;
receiving the location of the user-specified region and the document image; and
determining whether or not to execute image processing for deteriorating the document image for the user-specified region in the received document image in accordance with user information on a printer user.

14. The print processing method of claim 13, wherein the user-specified region is at least a portion of a region in the document image where an object is drawn, the user-specified region being specified by copy-inhibited information appended to the object.

15. The print processing method of claim 13, wherein the user-specified region is at least a portion of a region in the document image specified by an invisible object that is not printed out due to complete transparence.

16. The print processing method of claim 13, wherein the user-specified region is at least a portion of a region in the document image specified by an invisible object that is not printed out due to drawing operations with raster operation processing.

17. The print processing method of claim 13, wherein the user information on the printer user includes authorization level of the printer user.

18. The print processing method of claim 15, wherein the printer changes transmittance of the invisible object when determining to execute the image processing for deteriorating the document image.

19. The print processing method of claim 18, wherein the printer changes the transmittance of a plurality of invisible objects collectively.

20. The print processing method of claim 18, wherein the printer sets the transmittance in accordance with the user information on the printer user.

21. An image forming method, comprising the steps of:
specifying at least a portion of a region in a document image as a user-specified region in accordance with information contained in PDL data, the user-specified region representing a region where copying is inhibited; and
superimposing a security image on the user-specified region.

22. The image forming method of claim 21, wherein the user-specified region is at least a portion of a region in the document image specified by an invisible object that is not printed out due to complete transmittance.
